(19) United States
(12) Patent Application Publication
(10) Pub. No.: US 2003/0138365 A1
(43) Pub. Date: Jul. 24, 2003

(54) Pyrolysis system

(75) Inventors: Louis Obidniak, Laval (CA); Jacques Tetrault, Mirabel (CA); John Walker, Cambridge (CA)

Correspondence Address: MERCHANT & GOULD PC, P.O. BOX 2903, MINNEAPOLIS, MN, 55402-0903, US

(73) Assignee: Strudes Inc., Montreal (CA)

(21) Appl. No.: 10/325,662

(22) Filed: Dec. 19, 2002

(30) Foreign Application Priority Data
Dec. 19, 2001 (CA) 2,365,785

(51) Int. Cl. C10B 7/04; C10B 1/10; B01F 9/00

(52) U.S. Cl. 422/224; 422/225; 422/229; 202/216; 202/218; 202/265

(57) ABSTRACT

A pyrolysis system includes a generally cylindrical reactor chamber having two opposite ends and a longitudinal axis. The chamber has an inlet for receiving biomass, the inlet being adapted to prevent air from entering the chamber and being located at a first opposite end; a gas outlet for recuperating biogas produced in the reactor chamber, the gas outlet being adapted to prevent air from entering the chamber and being located at a second opposite end; and a solid outlet for recuperating charcoal produced in the reactor chamber, the solid outlet being adapted to prevent air from entering the chamber and being located at the second opposite end. The biomass is then subjected to indirect heating supplied by a heated rotor that decomposes the biomass in the absence of air or oxygen into a biogas and charcoal. A controller for controlling a rate of feed of biomass, extracted carbon residue and a temperature inside the reactor chamber is also provided. In a preferred embodiment, the shaft is heated by a portion of the energy recuperated from the pyrolysis system.

### FIELD OF THE INVENTION

The present invention is directed to a pyrolysis system for converting biomass into usable fuels.

### DESCRIPTION OF THE PRIOR ART

Bio-energy is derived from materials such as wood from forests, industrial forestry processes, agricultural and animal waste as well as industrial human residue. The energy value of biomass comes originally from solar energy- photosynthesis. The chemical energy stored in plants and animal all the way up the food chain as well as the waste that they produce. The production of biomass through photosynthesis is the only large-scale method for temporary storage of the sun's energy. The pyrolysis process reverses the process the plants use to grow; only water, nitrogen, CO2 and sunlight are required to produce this virtually unlimited renewable energy. Generated biogas contains mostly carbon and hydrogen based gases, which form compounds, many of which are combustible. The energy derived from biomass is a form of renewable solar energy. Using this energy recycles the carbon and does not add carbon dioxide to the environment in contrast to the fossil fuels, which release carbon stored millions of years earlier.

Pyrolysis systems are defined as the “endothermic” gasification of biomass using external energy. Pyrolysis technology is different from conventional incineration, because air or oxygen is not used in the pyrolysis conversion process. The pyrolysis reaction describes an endothermic reaction which absorbs or transfers heat to the biomass in the absence of the oxygen to produce biogas (also known as bio-energy) and char. The pyrolysis process can operate using a separate outside energy source or a percentage of its own gas to sustain the reaction.

Pyrolysis systems are known in the art. Such systems essentially consist of a reactor into which heat is applied to heat and converts a biomass present in the reactor into combustible biogas and char.

Most such systems permit the entry of air into the reactor, which makes the control of the reaction difficult, since combustion can occur.

Furthermore, most systems are very large, thereby requiring important investments to set them up.

Finally, most systems are not adapted to function continuously.

### SUMMARY OF THE INVENTION

It is an object of the invention to provide a pyrolysis system which is cost effective and automated, and obviates the deficiencies of the prior art.

In accordance with the invention, this object is achieved with a pyrolysis system comprising a generally cylindrical reactor chamber having two opposite ends and a longitudinal axis; an inlet for receiving biomass, said inlet being adapted to prevent air from entering said chamber and being located at a first opposite end; a gas outlet for recuperating biogas produced in said reactor chamber, said gas outlet being adapted to prevent air from entering said chamber and being located at a second opposite end; a solid outlet for recuperating charcoal produced in said reactor chamber, said solid outlet being adapted to prevent air from entering said chamber and being located at said second opposite end; means located inside said chamber for promoting movement of said biomass from said inlet towards said outlets and for heating said biomass in order to trigger a pyrolysis reaction within said reactor chamber; and control means for controlling a rate of feed of biomass and a temperature inside said reactor chamber.

In a preferred embodiment of the invention, the system includes a hollow shaft within said chamber, the shaft being provided with helical blades, and being driven in rotation. Furthermore, the shaft is heated by means of heated gas, preferably recuperated from the system itself. Alternatively, the shaft can be heated by electrical means.

In an alternative embodiment, the system includes a rotor having a plurality of tubes lying parallel to the longitudinal axis of the chamber, and mounted at their respective ends to flanges adapted to rotate. The tubes are each provided with electrical heating elements.

An aspect of the invention is that the inside of the chamber is sealed from the outside. Consequently, all inlet and outlets and assembly for heating the inside of the chamber must be gas-tight.

### BRIEF DESCRIPTION OF THE DRAWINGS

The present invention and its advantages will be more easily understood after reading the following non-restrictive description of preferred embodiments thereof, made with reference to the following drawings, in which:

FIG. 1 is a cross-sectional view of a pyrolysis system according to a preferred embodiment of the invention;

FIG. 2 is a cross-sectional view of a pyrolysis system according to another preferred embodiment of the invention; and

FIG. 3 is a cross-sectional view of a pyrolysis system according to yet another preferred embodiment of the invention.

### DESCRIPTION OF A PREFERRED EMBODIMENT OF THE INVENTION

The system of the present invention is designed to be a compact and automatic conversion system of biomass into usable fuels. All the components are tested and pre-assembled on a platform and ready to start operation upon delivery.

The automation and portability of this system reduces transport and installation time which helps reduce costs. The system contains a pyrolysis reactor unit which is smaller and more efficient than conventional reactors. The efficiency is achieved by using a new design consisting of a heated rotor inside of a stationary pyrolysis chamber shell. Biomass is injected at one end into the chamber through a gas tight air-lock, and is then subjected to indirect heating supplied by a heated rotor that decomposes the biomass in the absence of air or oxygen into a biogas and charcoal. The biomass is never burned but decomposed. Biogas generated inside the reactor's chamber is extracted from the system and is used by itself, or in conjunction with an existing fuel system to produce energy, as a fuel system to sustain the reaction, or both. Carbon residue is extracted out of the machine through a gas tight airlock at the opposite end of the biomass injector.

The proposed pyrolysis system helps maintain a clean environment, while converting biomass from most sources into energy. The system is a complete stand alone module used to process a designated biomass volume. The unit is fully scalable and capable of operating from zero to one hundred percent of its rated capacity as required, larger biomass volumes are processed by setting up parallel operations of identical equipment. Through careful management, the units can be strategically placed independently, or in clusters around a community in an effort to reduce associated transport problems and costs.

The system is designed to extract the maximum amount of energy from a given volume of biomass and is specifically designed to process unusable non-recyclable biomass. The system of the present invention will reduce most biomass organics to less than 15% of their original volume and render the remaining charcoal residue sterile. The charcoal is 85-95% carbon and the extracted biogas can be used as an independent energy source by the operator. The high-grade charcoal extracted from the machine can also be sold for use in laboratory and industrial applications.

The system is designed for continuous operation using an automated biomass feed process, thereby reducing handling and storage problems. Continuous automated operation maximizes efficiency and reduces human intervention and the associated costs.

In respect of the automation of the system of the present invention, at start-up the operator presses a start button and the system's logic controller takes over and automatically sequences through all systems functions. Numerous interlocks and thermocouples are monitored and controlled for safety and performance. Heat from an outside source is transferred across a physical barrier to the pyrolysis chamber. As the chamber heats up, gases in the chamber -initially air- expand and are driven out of the pyrolysis chamber to the outside. The temperature in the chamber increases further to the required level; biomass is introduced inside the chamber and begins to gasify. The gases continue to expand and are driven out of the chamber through the gas discharge port on the machine. Throughout this process there is no air entering the pyrolysis chamber, heat is introduced indirectly from an external source and is continually regulated to control the inside temperature of the chamber.

The pyrolytic destruction volatizes organic compounds in the absence of oxygen. Depending on the type of biomass being processed the pyrolysis reaction can begin at as low as 230 degrees Celsius when the volatile components of the biomass begin to gasify. Heat is continuously supplied to maintain the required internal temperature in the pyrolysis chamber resulting in complete gasification of all organic compounds in the biomass. The temperature level is related to the biomass organic composition and is controlled by the operator through the user interface.

When the biomass is gasified, these volatile compounds become known as Volatile Organic Compounds (VOCs). In the absence of air, the VOCs are not combusted, instead they are gently transferred in their gaseous state to the outside of the chamber to be used as an energy source. VOCs contain compounds which release their energy when they are oxidized (burned) as fuel.

To be economical and effective it is critical to select a design strategy which is easy to mass produce and incorporates the most effective technology. The production of small, automated and mass- produced systems appeared to the inventors of the present invention to be most practical strategy. In studying some the existing systems for processing biomass and converting it into an energy source we find problems and design errors which occur repeatedly.

The proposed pyrolysis system uses heat generated inside the reactor which is then channelled through the rotor to the inside the shell which contains the biomass. To achieve the best efficiency of biomass conversion it is necessary to maximize the ratio of thermal contact with biomass. The proposed internally heated rotor is designed to achieve this goal. This invention provides construction of a pyrolysis unit which is built using a stationary chamber shell with an internally heated rotor to move the biomass from feed end to discharge.

This invention incorporates three unique features.

The first is a fixed chamber heated insulated shell with a raw biomass feed opening and a biogas and char discharge ports. This requires a well designed front end biomass in-feed processing air lock mechanism which accepts raw biomass from the outside feeder. It must minimize the introduction of air and prevent biogas from escaping from the inside of the chamber as well as prevent unnecessary heat loss. The same security parameters apply to the biogas and charcoal discharge ports. The reliability and sealing efficiency of these items are important to secure safe and good operation of the pyrolysis unit.

The second unique feature is a rotor centrally located in the shell. The third unique feature is the automated control system.

According to one embodiment of the invention, heat generated on the outside of the reactor's chamber is forced from one end through the hollow shaft of the rotor and is discharged at, the opposite end. The heated rotor system is a completely sealed device rotating inside the internal chamber containing the biomass. The biomass is never subjected to the direct contact with the heat source inside or outside the chamber. The rotor's large heated surfaces result in very high heat transfer to the biomass. By varying the temperature and rotational speed of the rotor the retention time can be controlled to optimize conversion efficiency. These parameters are necessary to provide good distillation of the biomass generating various organics compounds. The heat required for the reaction of the pyrolysis system is automatically controlled by the flow of flue gases. An external burner to supply heat in a self-sustaining process uses part of the biogas exiting the reactor chamber.

According to another embodiment of the invention the hollow shaft of the rotor is equipped with the electric heating elements supplying the required heating energy inside the rotor system.

In yet another embodiment of the invention, the rotor's construction is modified and the central hollow shaft and the helical spade system is replaced by a multitude of horizontally rotating tubes, each equipped with their own electric heating elements.

This system records and controls all operational elements of the pyrolysis system reducing the human factor and minimizing interventions. The control system monitors temperature, flow rate, production levels as well as discharge rates in an effort to maximize production while minimizing human intervention.

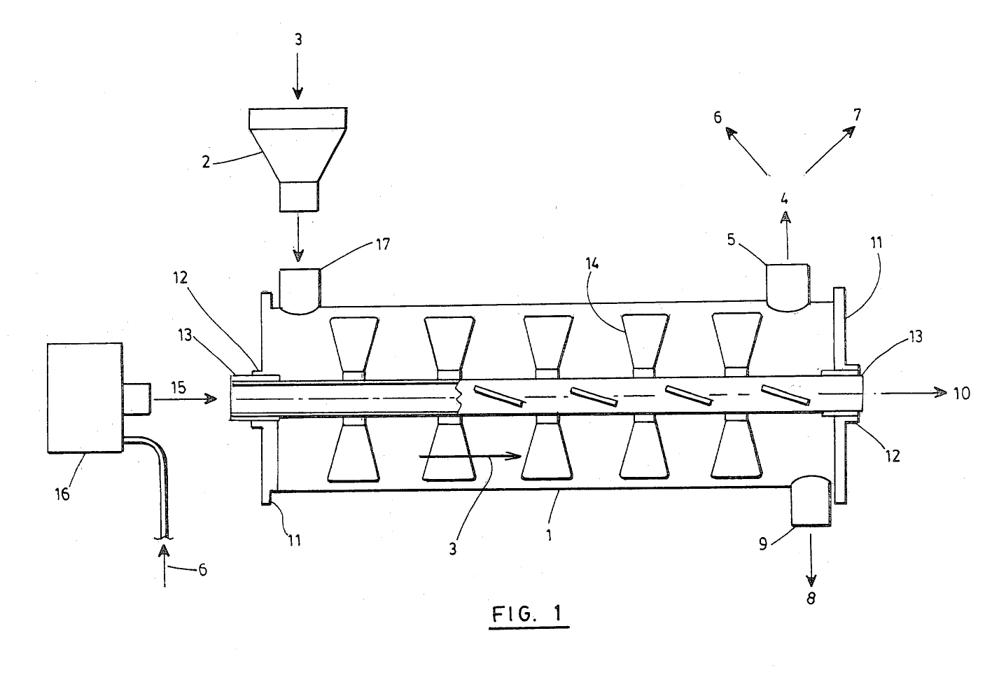

Referring now to the Figures, FIG. 1 is a cross-sectional view of a preferred embodiment of the present invention. The system includes a reactor shell having operating openings and containing a rotating hollow shaft. The hollow shaft is provided with a sheet metal helical spade system. The outside energy in the form of hot gases is supplied by a burner using a part of the biogas produced by the decomposition of biomass in the pyrolysis reactor. The heat supplied to the hollow shaft is transferred by metal to metal conduction process to the sheet metal of the helical spade system which transfers the heat to the surfaces of the biomass which is in-turn is converted to bio-energy.

More specifically, the system of the present invention comprises a fixed reactor shell 1 and a longitudinal, hollow shaft 13 adapted to rotate about an axis parallel to the longitudinal axis of the reactor and adapted to carry heat. The hollow shaft is provided with a helical spade system which collects the heat carried by the shaft and distributes the heat along the helical spade system.

The reactor is adapted to contain raw biomass, which is fed into the shell 1 through a feed system 2. An important aspect of the invention is that the reactor shell be air-tight, in order to prevent the ingress of oxygen into the reactor, in order to avoid triggering combustion of the biomass. Consequently, the feed system 2 is connected to the shell 1 through an in-feeding processing lock mechanism 17. The biomass 3, once inserted into the reactor, is transported longitudinally across the reactor area from an inlet to an outlet along the helical spade system. The granules of which the biomass consists of are split, dispersed and scattered through the reactor's interior volume and are exposed to heat. In the absence of air, the granules decompose into a biogas 4, which is discharged through a gas discharge port 5. Part of this biogas can be used for fuelling the self-sustaining burner 16 operation. The remaining major part of the biogas is directed toward an outside use as a fuel substitute for gas users located near the plant, or it can be collected and supplied to individual users. This gas can also operate an electro-generator.

The pyrolysis process reduces all biomass organics to less than 15% of their original volume to a charcoal, rendering this residue sterile and non-polluting. The charcoal discharge port 9 has its own air lock mechanism preventing air from entering the reactor chamber and preventing the loss of biogas. The flue gas 10 exiting from the reactor's chamber is directed across flow control (not shown) to the stack. This element controls the heat supplied to the reactor's chamber in conjunction with the burner control 16.

The reactor chamber is closed with two covers 11 having at their center two systems 12 of heat resistant bearings and seals for the rotating hollow shaft 13.

As mentioned previously, the hollow shaft 13 rotatingly supports a helical spade system 14, connected to it and which receives the heat from the hot gases 15 flowing inside the hollow shaft 13. The hot gases 15 pass through the shaft and are discharged as a flue gas 10. The hot gases 15 are completely sealed off from the interior of the reactor chamber, and from contacting the biomass. This heated helical spade system construction, with its great number of surfaces resulting in a greatly increased heat transfer area between the hot gases 15 and the biomass 3, increasing greatly the efficiency of the system of the present invention.

The burner 16 is preferably a low-BTU gas burner. The gas for the operation of the pyrolysis system is preferably a gas produced by the distillation of the biomass in the reactor=3 s chamber, rendering the system autonomous, in a way that it supports its own energy demand.

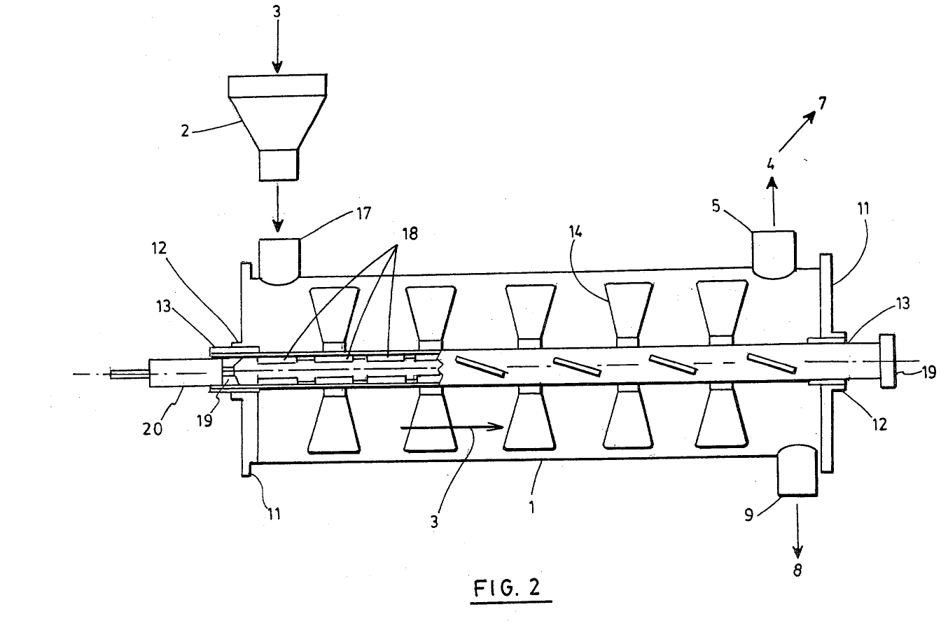

Referring now to FIG. 2, there is shown a cross-sectional view of another embodiment of the invention illustrating the same fixed chamber and centrally located and rotating hollow shaft with its attached helical spade system. The required heat for the distillation of the biomass is in the form of the electric current supplied to electric heating elements located inside of the rotating hollow shaft. The heat is supplied to the sheet metal of the helical spade system by metal to metal conduction from the central tube. In a sense, FIG. 2 illustrates an embodiment which differs from FIG. 1 in that heat inside the rotor tube is generated by electric element instead of by the biogas.

The heat required for the biomass distillation is supplied to the inside of the rotating hollow shaft 13 by the electric heating elements 18. This heating system is also gas-tight, sealed from the inside of the reaction chamber, and biomass is only subjected to the indirect heat conduction from the inside of the rotating hollow shaft 13. The inside of the hollow shaft is connected to the outside atmosphere though breathers 19, located on each end of the of the rotating hollow shaft. The electric conductors from the heating elements exit through the rotating hollow shaft insert 20, and are connected to a slip ring and electric heating control assembly (not shown).

This type of pyrolysis heating system represents a simpler construction of the hollow shaft assembly since the required electric energy can be supplied by an electric grid system. Alternatively, the electricity can be supplied by an electro-generating unit using as the energy source biogas from the reactor, rendering the pyrolysis system autonomous, in a way that it supports its own energy demand.

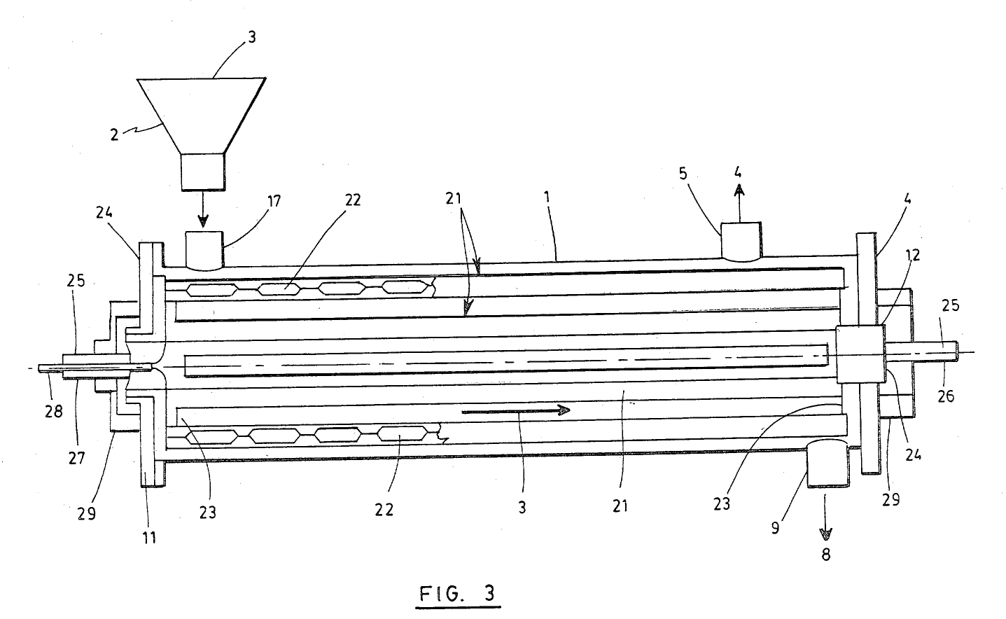

Referring now to FIG. 3, there is shown a cross-sectional view of yet another preferred embodiment, illustrating the same fixed shell but having a rotor composed of a plurality of horizontal, straight tubes lying in the axis generally coincidental with the transversal axis of the reactor. Each tube is provided with electric heating elements, which are sealed from the inside of the chamber. The tubes are affixed on each end to the rotating flanges. The electric heating elements are connected to an outside electric energy source. The tubes are connected to the outside atmosphere through the breathers located on each end of the rotating hollow shafts. The heat is conducted from the inside of these tubes to the inside of the pyrolysis chamber and its biomass.

The reactor has the same operating openings as in FIGS. 1 and 2, but the centrally located rotor is composed of a multitude of horizontal, radial, straight tubes 21. Each tube lies in an axis generally coincident with the transversal axis of the fixed reactor chamber 1.

Each tube is provided with electric heating elements 22 therein, which are gastight sealed from the inside of the reactor. The tubes are fixed on each end to the rotating flanges 23. The flanges have their hollow shaft 24, which are also gastight assembled, and which are rotationally supported by the flanges 11, having at their center two systems 12 of heat resistant bearings and seals. All tubes are connected to the outside atmosphere through breathers 25. The hollow shaft 26 can be used as drive shaft, while hollow shaft 27 conducts all the electric wires 28 from the heating elements to the outside slip-ring and electric energy source supply (not shown).

The hollow shafts 26 and 27 are supported by assemblies 29, which are connected to the flanges 11.

The required heat is conducted from the inside of each rotating tube to the inside of the reactor's chamber.

As mentioned before, this plurality of horizontal heating tubes 21, and their circular location in the reactor chamber, can be an important feature while processing a biomass requiring distinct and regulated heat supply for its decomposition in the reactor.

Although the present invention has been explained hereinabove by way of a preferred embodiment thereof, it should be pointed out that any modifications to this preferred embodiment within the scope of the appended claims is not deemed to alter or change the nature and scope of the present invention.

1. A pyrolysis system comprising:
(a) a generally cylindrical reactor chamber having two opposite ends and a longitudinal axis;
(b) an inlet for receiving biomass, said inlet being adapted to prevent air from entering said chamber and being located at a first opposite end;
(c) a gas outlet for recuperating biogas produced in said reactor chamber, said gas outlet being adapted to prevent air from entering said chamber and being located at a second opposite end;
(d) a solid outlet for recuperating charcoal produced in said reactor chamber, said solid outlet being adapted to prevent air from entering said chamber and being located at a bottom of said second opposite end;
(e) means located inside said chamber for promoting movement of said biomass from said inlet towards said outlets and for heating said biomass in order to trigger a pyrolysis reaction within said reactor chamber; and
(f) automatic control means for controlling at least a rate of feed of biomass and a temperature inside said reactor chamber.

2. A system according to claim 1, wherein said means located inside said chamber include a hollow shaft having a rotation axis coincident with said longitudinal axis of said chamber, said hollow shaft being provided with a helical blade system, said shaft being heated by hot air, said shaft being driven in rotation by a motor controlled by said control means, and being sealed from the inside of said chamber.

3. A system according to claim 2, wherein said hot air consists of a portion of the biogas produced in said reactor chamber which is burnt by a burner and circulated within said shaft.

4. A system according to claim 1, wherein said means located inside said chamber include a hollow shaft having a rotation axis coincident with said longitudinal axis of said chamber, said hollow shaft being provided with a helical blade system, said shaft being heated by electric heaters placed within said shaft, said shaft being driven in rotation by a motor controlled by said control means, and being sealed from the inside of said chamber.

5. A system according to claim 1, wherein said means located inside said chamber include a plurality of horizontal tubes, each tube lying in an axis generally parallel with said longitudinal axis, each tube being provided with electrical heating elements therein, said tubes being mounted to two flanges, one at each opposite end of said chamber, said flanges being adapted to rotate about an axis parallel to said axis of said chamber and being sealed from the inside of said chamber.

6. A system according to claim 1, wherein said automatic control means are further adapted to control a rate of discharge and includes a user interface for specifying operating parameters.
